(19) United States
(12) Patent Application Publication
(10) Pub. No.: US 2014/0252665 A1
(43) Pub. Date: Sep. 11, 2014

(54) DISTURBING DEVICE OF OXYGENATED WATER MACHINE

(71) Applicant: BIYOUNG BIOTECHNOLOGY CO., LTD., Tortola (GB)

(72) Inventors: Chien-An Chen, Kaohsiung (TW); Shu-Fen Lee, Taipei (TW); Chei-Wei Lin, Kaohsiung (TW)

(73) Assignee: BIYOUNG BIOTECHNOLOGY CO., LTD., Tortola (GB)

(21) Appl. No.: 13/845,563

(22) Filed: Mar. 18, 2013

(30) Foreign Application Priority Data
Mar. 8, 2013 (TW) 102204363

(51) Int. Cl. B01F 3/04

(52) U.S. Cl. CPC B01F 3/04468
USPC 261/114.1

(57) ABSTRACT

A disturbing device of an oxygenated water machine includes a frame, two wing board, and a separating board. The wing boards are connected to an inner side of the frame, and slope downward. A gap is formed between the wing boards. Each wing board is provided with several ribs on a bottom sides. The separating board is connected to the inner side of the frame and is right under the gap. Therefore, water falls down from the wing board and onto the separating board, and oxygen goes up in a S path from a bottom edge of the frame. It is helpful to the dissolution of oxygen to obtain high oxygenated water.

### BACKGROUND OF THE INVENTION

1. Technical Field

The present invention relates to oxygenated water, and more particularly to a disturbing device of an oxygenated water machine.

2. Description of Related Art

In present days, people drink oxygenated water to let oxygen come into body and to be absorbed by tissue directly. It makes a growth of stimulatory effect on normal cells for an improvement of health. However, it is hard to dissolve oxygen in water in a high concentration, and keep the oxygenated water in such high concentration.

In the conventional method of making high-oxygenated water, the usage rate of oxygen is very low (only about 10%) so that the manufacture has to provide a huge oxygen tank to reduce the repeating times for dissolving oxygen. However, it is applied in a mass production, and not in personal use. Besides, it needs a large water tank, so that the process can't be applied in a user's house.

### BRIEF SUMMARY OF THE INVENTION

In view of the above, the primary objective of the present invention is to provide a disturbing device of an oxygenated water machine to extend the contact time of oxygen and water and increase the oxygen concentration in the oxygenated water.

The present invention provides a disturbing device of an oxygenated water machine, including a frame, at least one wing board, and a separating board. The wing board is connected to an inner side of the frame at a position adjacent to the top edge, and slopes downward from the inner side to a center of the frame. Therefore, a gap is formed beside the wing board. The separating board is connected to the inner side of the frame and is right under the gap.

Therefore, water falls down from the wing board and onto the separating board, and oxygen goes up in a S path from a bottom edge of the frame. It is helpful to the dissolution of oxygen to obtain high oxygenated water.

### BRIEF DESCRIPTION OF THE SEVERAL VIEWS OF THE DRAWINGS

The present invention will be best understood by referring to the following detailed description of some illustrative embodiments in conjunction with the accompanying drawings, in which

FIG. 1 is a perspective view of a preferred embodiment of the present invention;

FIG. 2 is a top view of the preferred embodiment of the present invention;

FIG. 3 is a sectional view of the preferred embodiment of the present invention;

FIG. 4 is a sectional view in the A-A′ line of FIG. 2; and;

FIG. 5 is sectional view, showing the disturbing device in the tank.

### DETAILED DESCRIPTION OF THE INVENTION

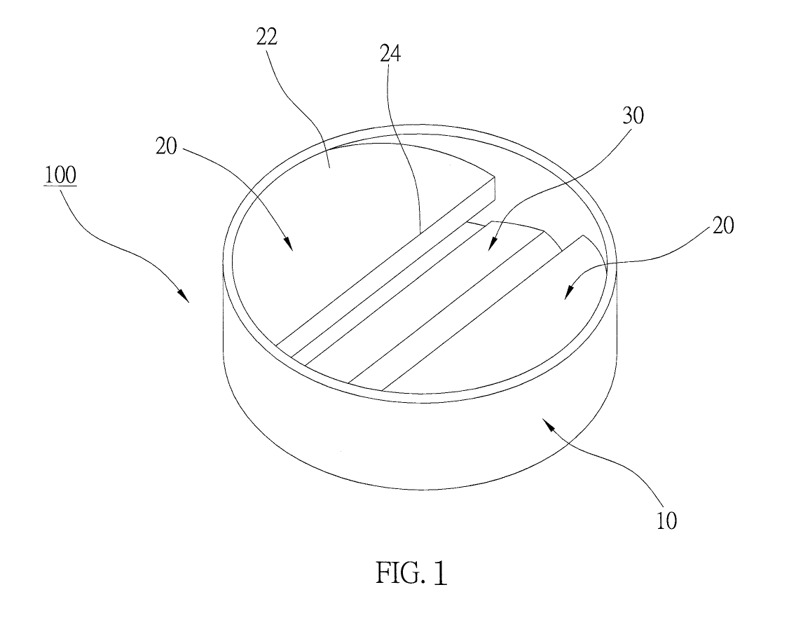

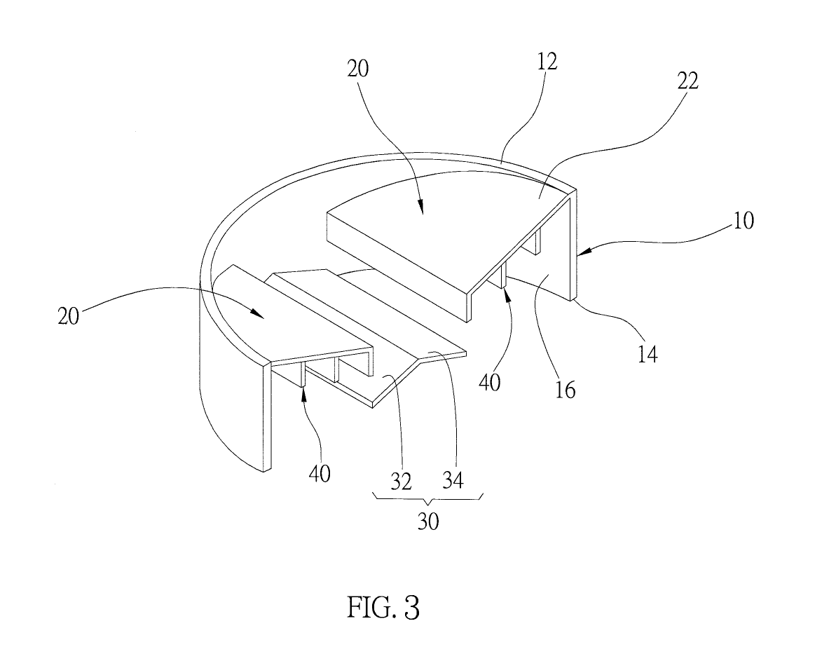

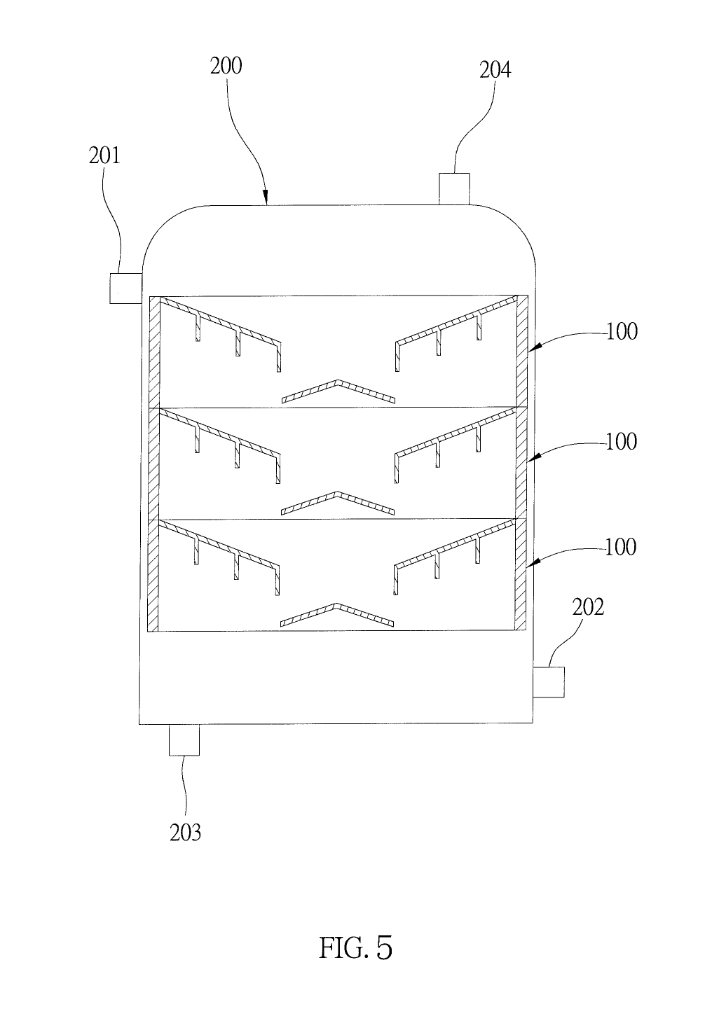

As shown in FIGS. from FIG. 1 to FIG. 4, a disturbing device 100 of the preferred embodiment is installed in a tank 200 of an oxygenated water machine (FIG. 5). In practice, it may provide two or more disturbing devices 100 in the tank 200 according to requirements. The tank 200 has a water inlet 201, a water outlet 202, a gas inlet 203, and a gas outlet 204. The water inlet 201 is on a top of the tank 200 for water flowing into the tank 200. Oxygenated water flows out of the tank 200 via the water outlet 202. The gas inlet 203 is on a bottom of the tank 200 for pure oxygen coming into the tank 200, and the pure oxygen is dissolved in the water in the tank 200. The gas outlet 204 is normally closed, and is opened for gas exchange.

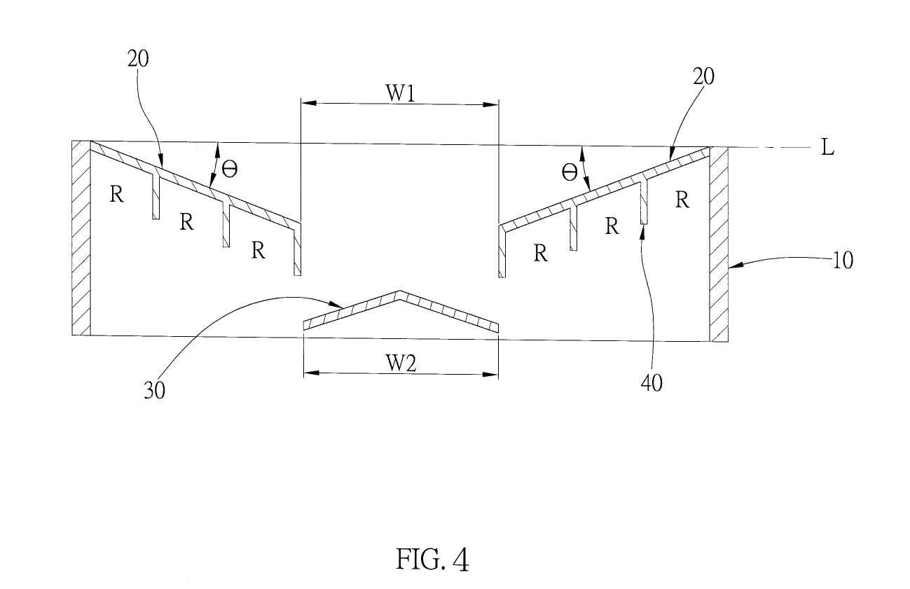

The disturbing device 100 includes a frame 10, two wing boards 20 (a first wing board and a second wing board), and a separating board 30. The frame 10 is a hollow cylinder, having a top edge 12, a bottom edge 14, and an inner side 16. The wing boards 20 respectively are connected to the inner side 16 of the frame 10 in symmetry. As shown in FIG. 1, the wing boards 20 are semicircle, each of which has a first side 22 at the round edge and a second side 24 at the flat edge. The first sides 22 of the wing boards 20 are connected to a left and a right of the inner side 16 and are adjacent to the top edge 12. Both the wing boards 20 slope downward from the inner side 16 to a center of the frame 10. As shown in FIG. 4, an included angle θ between a horizontal plane L and the wing board 20 is between 15 degrees and 20 degrees, and a preferable angle θ is 19 degrees. In our test, 19 degrees is the best slope for water to flow through the wing boards 20.

Each wing board 20 is provided with a plurality of ribs 40 on a bottom side thereof. As shown in FIG. 4, the ribs 40 are parallel to the second side 24 of the wing board 20 and are vertical to the horizontal plane L. Between each two of the neighboring ribs 40 is an exchanging room R. Oxygen will stay in the exchanging rooms R to extend the time for the oxygen to be dissolved in water. It is easy to understand that more disturbing devices 100 installed in the tank 200 may extend the time for the oxygen contacting the water.

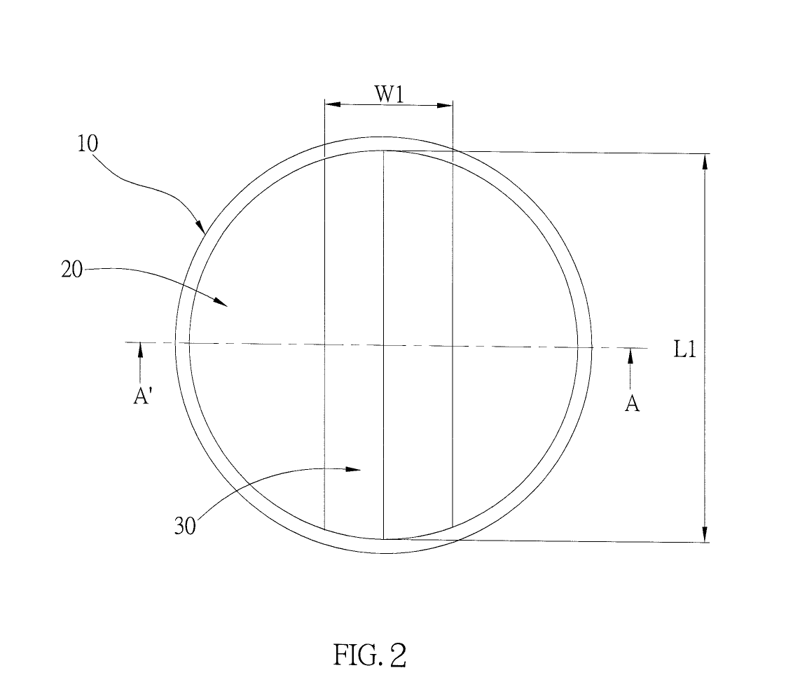

As shown in FIG. 2 and FIG. 4, a gap is formed between the second sides 24 of the wing boards 20, and the gap has a length L1 and a width W1. The width W1 is a distance between the second sides 24 of the wing boards 20, and a direction of the length L1 is perpendicular to the width W1. The separating board 30 has opposite ends connected to the inner side 16 of the frame 10. The separating board 30 is right under the gap between the wing boards 20. A length of the separating board 30 is equal to the length L1 of the gap, and a width W2 of the separating board 30 is equal to the width W1 of the gap. In an embodiment, the width W2 of the separating board 30 is greater than the width W1 of the gap. The separating board 30 has two inclined faces 32, 34, which slope downward from a middle of the separating board 30 to opposite sides. The separating board 30 separates the water flowing down from the wing boards 20. It may extend the time for the oxygen staying in the tank 200 and guide the oxygen to the exchanging rooms R.

In conclusion, the inclined wing boards 20 working with the ribs 40 and the separating board 30 may extend the time for oxygen staying in the disturbing device 100 that is helpful to the dissolution of oxygen to obtain oxygenated water with high oxygen concentration.

It must be pointed out that the embodiments described above are only some preferred embodiments of the present invention. All equivalent structures and manufacturing methods which employ the concepts disclosed in this specification and the appended claims should fall within the scope of the present invention.

What is claimed is:

1. A disturbing device of an oxygenated water machine, comprising:
a frame, which is a hollow member, having a top edge, a bottom edge, and an inner side;
a first wing board having a first side and a second side, wherein the first side of the wing board is connected to the inner side of the frame at a position adjacent to the top edge, and the wing board slopes downward from the first side to the second side;
the wing board having at least a rib on a bottom side thereof; and
a separating board connected to the inner side of the frame, wherein the separating board is closer to the second edge of the frame than the wing board.

2. The disturbing device of claim 1, further comprising a second wing board connected to the inner side of the frame, wherein the second wing board is symmetrical to the first wing board, and has at least a rib on a bottom side thereof.

3. The cleaning system of claim 2, wherein an included angle between a horizontal plane and the first wing board or the second wing board is between 15 degrees and 20 degrees.

4. The disturbing device of claim 2, wherein a gap is formed is formed between the first wing board and the second wing board; the gap has a width, which is a distance between the first wing board or the second wing board, and the width of the gap is shorter than a width of the separating board.

5. The disturbing device of claim 4, wherein the separating board has two inclined faces, which slope downward from a middle of the separating board to opposite sides respectively.

6. A disturbing device, which is installed in an oxygenated water machine, comprising:
a frame having an inner side;
two wing boards respectively connected to the inner side of the frame in symmetry, wherein both the wing boards slope downward from the inner side to a center of the frame, and a gap is formed between the wing boards;
the wing board having at least a rib on a bottom side thereof; and
a separating board connected to the inner side of the frame, wherein the separating board is under the gap;
wherein the gap has a width, which is a distance between the wing boards, and the width of the gap is shorter than a width of the separating board.

7. The disturbing device of claim 6, wherein each of the wing boards has at least a rib on a bottom side thereof.

8. The disturbing device of claim 6, wherein an included angle between a horizontal plane and the wing board is between 15 degrees and 20 degrees

9. The disturbing device of claim 6, wherein the separating board has two inclined faces, which slope downward from a middle of the separating board to opposite sides respectively.
